(19) United States
(12) Patent Application Publication
(10) Pub. No.: US 2005/0083018 A1
(43) Pub. Date: Apr. 21, 2005

(54) Battery charge regulator

(76) Inventor: James S. Morrow, Redmond, WA (US)

Correspondence Address: James S. Morrow, P.O. Box 2472, Redmond, WA, 98073, US

(21) Appl. No.: 10/967,478

(22) Filed: Oct. 18, 2004

Related U.S. Application Data
(60) Provisional application No. 60/512,647, filed on Oct. 20, 2003.

(51) Int. Cl. H02J 7/00

(52) U.S. Cl. 320/128

(57) ABSTRACT

An apparatus for and method of a charge regulator for a battery that will be easy to use, have less maintenance, and automatically adjust itself to varying conditions of use. This method of charge regulation eliminates some of the problems encountered when a traditional type of charge regulator is used with photovoltaic cells. The charge regulator will determine the initial charge remaining in the battery before charging begins, calculate what is needed to bring the battery to full charge, then start charging the battery. Charging is discontinued after the initial charge plus the charge received equals the equivalent of a fully charged battery.

### PRIORITY CLAIM

This application claims priority from Provisional Application No. 60/512,647, filed Oct. 20, 2003, which is incorporated herein by reference.

### BACKGROUND OF THE INVENTION

1. Field of the Invention

The present invention relates generally to battery chargers, and in particular, to a charge regulator for lead acid batteries that automatically adjusts to the charging conditions.

2. Description of the Prior Art

Typically, a stand-alone renewable energy system is comprised of multiple components. These components include a renewable power source (such as photovoltaic cells), a charge regulator, and batteries (such as lead acid batteries).

Presently, most renewable energy systems use a three-stage charge regulator having three modes of operation. The charge regulator begins operating in a first mode of operation and regulates current into the battery until the battery voltage reaches a predetermined value. At this point, the charge regulator starts operating in a second mode of operation and regulates voltage to the battery. During this second stage, the charging current decreases until the current reaches a low enough level. The charge regulator then operates in a third mode of operation and regulates the voltage to the battery at a lower level, 2.3 volts per cell for a lead acid type of battery, so as to maintain the charge on the battery without overcharging it.

The inventor has found that when this type of charge regulator is used with a power source that is removed and reapplied on a regular basis, such as photovoltaic cells providing power during daylight hours and no power at night, the battery will become over charged when it is not being used. The overcharge condition results from the repeated application of power to the 3 state charger connected to a fully charged battery. After power has been off for a while, the battery voltage drops to a terminal voltage of 2.1 volts per cell for a fully charged lead acid battery. When power is applied to the charger, the 2.1 volts per cell is less than then the 2.3 volts per cell that the three state battery charger expects to see on the battery thus causing current to flow into the battery which in turn causes the three state battery charger to start charging the battery for a short time. The repeated charging events result in an over charged battery.

Another drawback to using such an energy system is the maintenance needed to compensate for the variation in the usage of the battery. The use or load demanded from the battery can vary from day to day, or week to week, resulting in a situation of battery being charged too much occasionally. Typically, the user must manually adjust the charge regulator output voltage to be lower to maintain correct battery hydrometer readings when the system is not in use. When a change in usage increases again, the user must make adjustments to raise the voltage again. Time consuming hydrometer measurements to determine the specific gravity of the battery acid must be made to fine tune the charger output voltage to match the actual usage of the battery. The state of charge (SOC) of the battery can be determined from the battery acid specific gravity measurements when the battery is being used. If the battery is not being charged enough, or if it is being overcharged, the life of the battery will be decreased substantially. The charge regulator output voltage must then be adjusted to compensate for any under or overcharge condition.

Examples of applications where the battery usage changes include: a remote residence or cabin used on the weeked, an out-building on a farm, and marine applications. In these situations, the battery provides power for a few days and then is left unused for days, weeks or months.

### OBJECTS AND ADVANTAGES

Accordingly, there is a need for a system that automatically makes adjustments to the amount of charge that the battery receives as battery usage changes. Such a system would measure the battery State Of Charge (SOC) before charging and then provide the amount of charge necessary. Such an automated system would provide for increased battery life and system reliability. Several other objects and advantages of the present invention are: 1) the elimination of the maintenance associated with adjusting the battery charger voltage; 2) allows use by a greater number of individuals including those who do not have a technical understanding of batteries and/or electrical power systems; 3) reduced warrantee costs due to the elimination of user errors.

### SUMMARY OF THE INVENTION

An embodiment of the present invention provides a charge regulator for a battery. The charge regulator includes a charging circuit operable to selectively couple the battery to a charging source, and a control circuit operable to cause the charging circuit to provide a predetermined amount of charge to the battery based on a measurement of charge flowing into the battery.

Another embodiment of the present invention provides a system including a charging source, a first battery, and a charge regulator. The charge regulator includes a first charging circuit operable to selectively couple the first battery to the charging source, and a first control circuit operable to cause the first charging circuit to provide a predetermined amount of charge to the first battery based on a measurement of charge flowing into the first battery.

A further embodiment of the present invention provides a method of regulating charge in a battery. The method includes determining an initial charge of the battery after a rest period during which the battery is open-circuited, charging the battery, monitoring the charge accumulated by the battery, and ending the charging of the battery when the sum of the initial charge and the accumulated charge substantially equals a desired level.

### BRIEF DESCRIPTION OF THE DRAWINGS

FIG. 1 is a block diagram of a basic renewable energy system.

FIG. 2 is a block diagram of a first embodiment of a charge regulator of the present invention that allows for the battery to be used during the Charging cycle.

FIG. 3 is a block diagram of a second embodiment of a charge regulator of the present invention, which is a lower cost solution for applications that do use the battery during the charging cycle.

FIG. 4 is a block diagram of a third embodiment of a charge regulator of the present invention, which is a lower cost solution for applications having a low charge rate.

FIG. 5 is a block diagram of an embodiment of a system that is composed of functions and circuits that are the equivalent of two battery charge regulators of the present invention of the type shown in FIG. 2.

FIG. 6 is a timing diagram of a startup sequence of a charge regulator of the present invention.

FIG. 7 is a block diagram of an embodiment of a system that uses multiple charge regulators of the present invention and multiple batteries.

### DRAWINGS—REFERENCE NUMERALS

12 Battery charge regulator of the present invention.
14 Power source—shown as photovoltaic cells.
16 Battery.
18 Current sensor.
20 Control Logic Power—regulated low voltage for a the electronic ICs.
22 Measure voltage circuit—circuit that measures the battery voltage
28 Total charge on Battery—sum of the initial and accumulated charge.
32 On/off latch—a means of remembering the desired state of circuit operation.
34 Charge control—Controls the current and/or voltage to the battery.
38 Turn on sequence and clock—Provides the correct sequence of functions for the desired operation.
40 Transfer switch—Provides a charging system the means of selecting which battery is used and which battery is at rest.
42 Load—Item that the customer wants to use, usually a light.
44 Connection for second source of power—Second source of power is externally supplied, usually a second battery.
48 Battery charging System—uses two or more of the charge regulators of the present invention, or uses multiple functions and circuits described in the present invention.
52 Output of the charge control.
54 Voltage sense connection.
56 Signal that controls when the voltage measurement is made.
58 Data that corresponds to the measured state of charge of the battery.
60 Control signal that will turn off the on/off latch.
62 Control signal that will turn on the on/off latch.
64 Charger control on/off signal.
66 Current sensor signal that corresponds to charging the battery.
68 Current sensor signal that corresponds to current to the load.
70 Signal to stop discharging the battery when the battery is low.
74 Signal that turns everything off about six hours before the next charge cycle.
76 Signal to turn the load on after the battery has charged for awhile.

### DESCRIPTION OF THE PREFERRED EMBODIMENTS

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment shown, but is to be accorded the widest scope consistent with the principles and features disclosed herein.

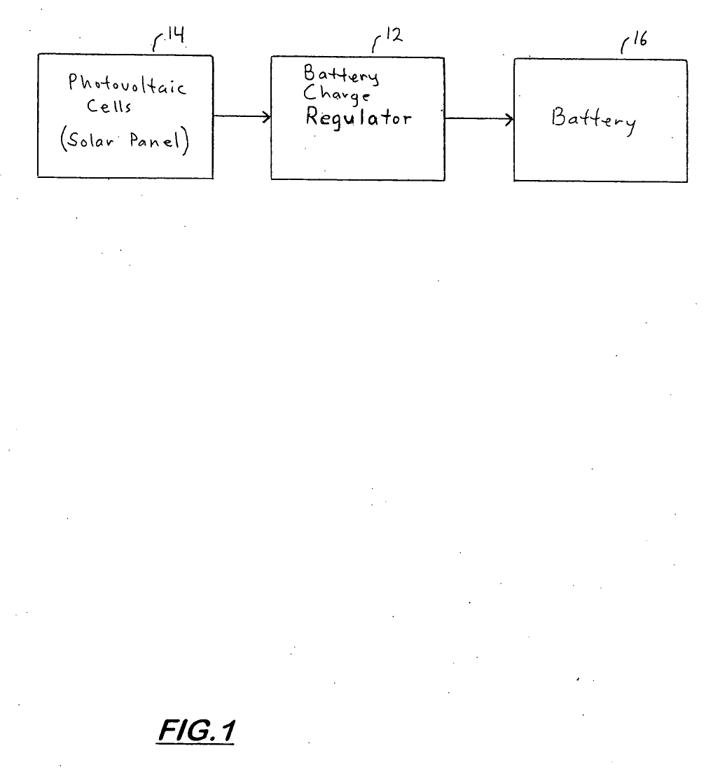

FIG. 1 shows how the present invention 12 would be used with a power source 14 (shown as photovoltaic cells), and a battery 16.

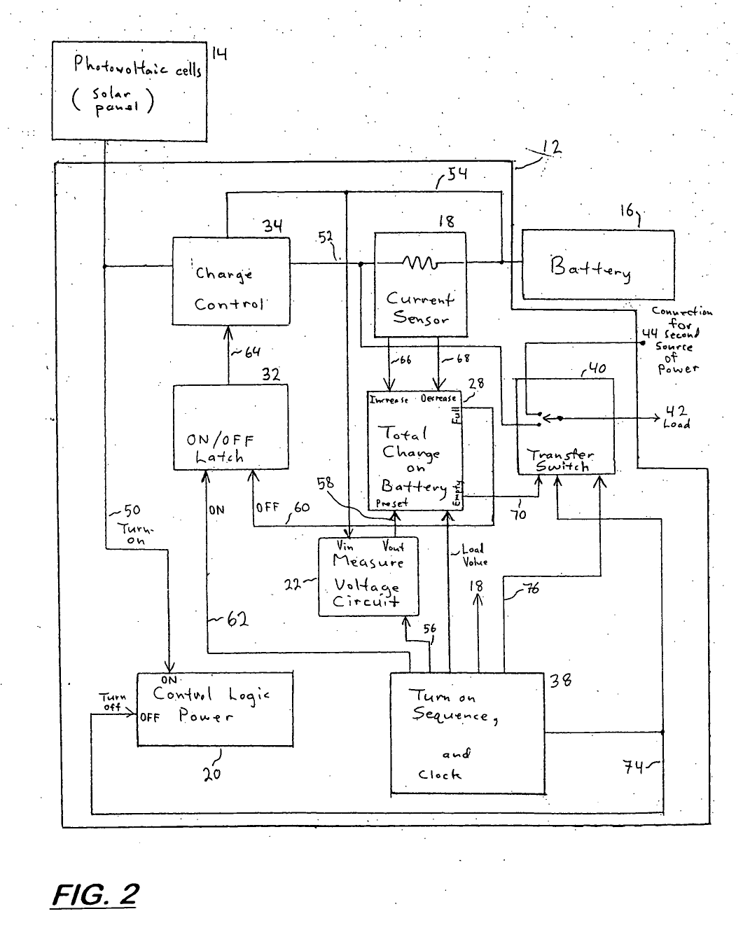

FIG. 2 shows a first embodiment of an automatic battery charge regulator 12 of the present invention and includes photovoltaic cells 14 and at least one battery 16.

The power source 14 (shown as photovoltaic cells) connect to the battery charge regulator 12 by means of wires 50. Inside the battery charge regulator 12, power connects to the charge control 34 and the control logic power 20. The control logic power 20 connects to all the electronic circuits. The charge control 34 connects to a current sensor 18 by means of wire 52. The current sense function 18 connects to the battery 16, and the charge control 34 by means of wire 54.

A voltage measure circuit 22 is electronically connected to the battery 16 through wire 54. The measure voltage circuit 22 connects to the Total Charge on Battery 28 through wire 58.

A turn on sequence and clock 38 connects to the measure voltage circuit 22 through wire 56, connects to the load transfer switch 40 through wire 76, connects to the total charge on battery 28, and connects to the on/off latch 32.

A load transfer switch 40 connects the load 42, to the current sensor 18, and to a connection for second source of power 44. The connection for second source of power 44 is a place to connect an optional second source. The second source of power would be externally provided by the user. It would most likely be a second battery.

The current sensor 18 connects to the total charge on battery 28 through wires 66 and 68. The total charge on battery 28 connects to the load transfer switch 40 through signal 70, and the on/off latch 32 through signal 60. The on/off latch 32 connects to the charge control 34 through signal 64. The turn on sequence and clock 38 connects to the control logic power 20 and to the load transfer switch 40 through signal 74.

Operation—FIGS. 2, 3, 4, 5, 6, 7

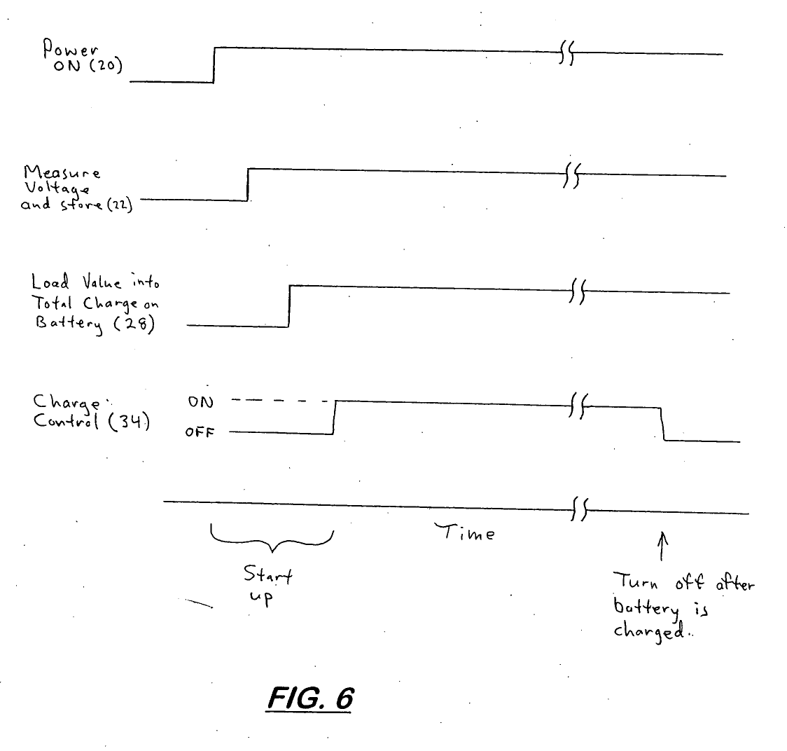

A representative charging system operation will be described in more detail with reference to FIGS. 2 and 6.

When the lead acid battery 16 has been sitting at least six hours without being charged or discharged, the open-circuit battery voltage will relate to the amount of charge remaining in the battery as shown in Table 1. The amount of charge remaining in the battery is referred to as the state-of-charge (SOC).

TABLE 1
Battery Voltage vs. State-of-Charge
(after six hours of no battery current flow)

| Battery Voltage | State-of-Charge |
|---|---|
| 12.6 | 100% |
| 12.5 | 83% |
| 12.4 | 67% |
| 12.3 | 50% |
| 12.2 | 33% |
| 12.1 | 17% |
| 12.0 | 0% |

With reference to FIG. 2, an embodiment of the battery charge regulator 12 of the present invention.

Operation begins with the battery 16 being at rest, no charging or discharging. Power (shown as photovoltaic cells 14) is applied to the battery charge regulator 12 by wire 50, which then provides power to control logic power 20 and the charge control 34. The control logic power 20 supplies regulated low voltage to all the electronic circuits within the battery charge regulator 12 of the present invention.

This is the beginning of the start up sequence. With control logic power 20 available, the turn on sequence and clock 38 provide the necessary sequence of signals for the desired operation as shown in FIG. 6. Next the measure voltage circuit 22 is directed by signal 56 to measure the battery 16 voltage through wire 54. The battery 16 voltage is used to determine the battery 16 State Of Charge (SOC).

The turn on sequence and clock 38 signals the SOC data to be loaded into the total charge on battery 28 function. The SOC data is moved from the measure voltage circuit 22 to the total charge on battery 28 by signal 58. The turn on sequence and clock 38 then provides a signal 62 to turn on the on/off latch 32. Signal 64 from the on/off latch 32 holds the charge control 34 in the desired on or off state. With the charge control 34 turned on, the start up sequence is complete and the battery 16 is now being charged. This start-up sequence happens each time the source of power 14 becomes available to battery charge regulator 12.

After the start-up sequence is complete and the charge control 34 is on, current from the power source 14 flows by means of wire 50 to the charge control 34. The current flows through the charge control 34, through wire 52 to current sensor 18, through current sensor 18, through wire 54 to battery 16 thereby charging the battery 16. The charge current is continuously monitored by the current sensor 18.

After the battery 16 has charged for a short time, the signal to turn the load on 76 causes the load 42 to be electronically reconnected to the battery 16 being charged. It is reconnected through the current sensor 18.

During installation, the user only needs to set the amp-hour rating of the battery into the battery charge regulator 12. The battery amp-hour information is used to create a relationship between the charging current and the amount of charge the battery 16 has received.

The battery amp hour information is then used to modify the rate at which the value in the total charge on battery 28 changes for a given current.

When the battery is being charged, the current sensor signal 66 causes the value in the total charge on battery 28 is increasing. When the battery is being discharged, the current sensor signal 68 causes the value in the total charge on the battery 28 to be decreasing.

When the value in the total charge on battery 28 increases to a point that corresponds to the battery being fully charged, a signal on wire 60 goes to the on/off latch 32 causing it to turn off the charge control 34. This discontinues the charging current to the battery 16.

Another method of discontinuing charging is to have the voltage of charge control 34 regulate to 12.6 volts for the purpose of being able to power load 42 connected to the battery 16 without discharging or charging the battery 16 when power is available.

If the load 42 on the battery 16 is greater than the current charging the battery 16, then the value in the total charge on battery function 28 will be decreasing. When this value reaches a point that corresponds to a safe level of discharge, the signal to stop discharging the battery 70 will cause the load 42 to be shut off or transferred to the connection for second source 44 by the transfer switch 40. When power is connected to the connection for second source 44, the load will continue working when the battery 16 is depleted and during the rest time for the battery 16.

When the battery charge regulator 12 is used with photovoltaic cells, power becomes available at sunrise. The total cycle time equals 24 hours. The turn on sequence and clock 38 is set to turn everything back of after 18 hours. After 18 hours has elapsed, six hours before the start of the next charge cycle, the turn on sequence and clock 38 provides a signal 74 to the transfer switch 40 to turn off the load 42 from the battery 16. Signal 74 also turns off the control logic power 20. At this time there is no current flow into or out of the battery.

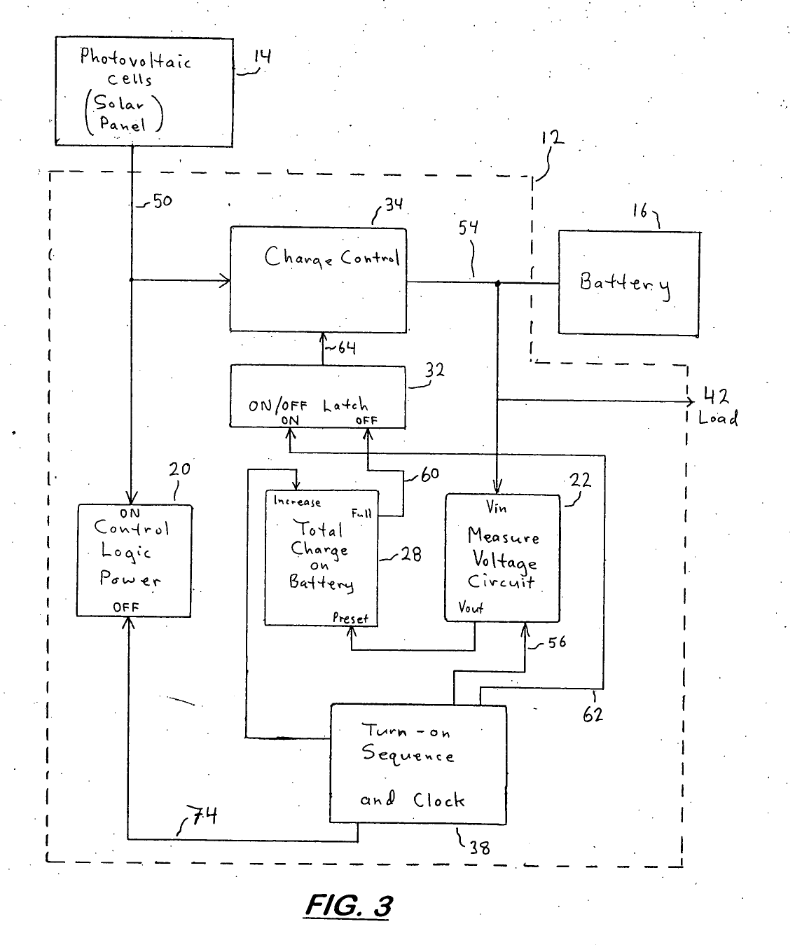

FIG. 3 shows a second embodiment of a charge regulator of the present invention, which is a lower cost solution of the embodiment of FIG. 2, for applications that do not use the battery during the charging cycle. The second embodiment of FIG. 3 has the same functional operation as that of the first embodiment of FIG. 2 with the only difference being the details of how the electronic circuits determine the point at which the charging stops. When the battery is not used during the charge cycle, we can assume a constant charge current and there for only need to control the time during which the charging current flows. The time that the charging current flows will correspond to the amount of charging that the battery needs.

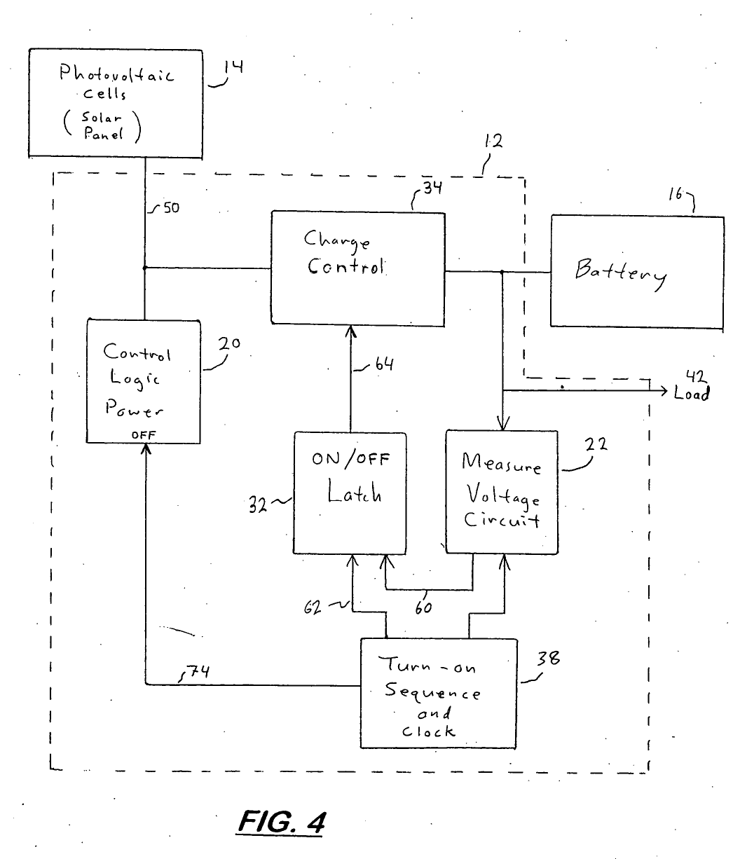

FIG. 4 shows a third embodiment of a charge regulator of the present invention. The third embodiment has the same functional operation as that of the first embodiment of FIG. 2 with the only difference being the details of how the electronic circuits determine the amount of charge to provide the battery. When power for charging the battery is low (such as low cost photovoltaic cells) compared to the capacity of the battery such that it takes many days to fully charge the battery, the measurement of charge the battery has received can be simplified. This simplified alternative only has to make a measurement at the beginning of each charge cycle (each day when used with photovoltaic cells) and then reduces the voltage for charging when the battery is approaching a full charge condition.

The following is a typical sequence of operation when the charge regulator of the present invention is used with photovoltaic cells.
i. Before sunrise the battery is at rest, no charging or discharging.
ii. At sunrise, power is available to the charge regulator and the start sequence begins.
iii. The battery voltage is accurately measured. This voltage relates to the state of charge.
iv. The battery state of charge information is stored. A calculation is made to determine how much to charge the battery.
v. The charge regulator is turned on and battery charging begins.
vi. Charging is stopped when the initial state of charge plus the charge received equals the amount that will correspond to a fully charged battery.
vii. The battery is available for use.
viii. The battery is allowed to rest, no charge or discharge, for six hours before the start of the next charging cycle for the same battery.

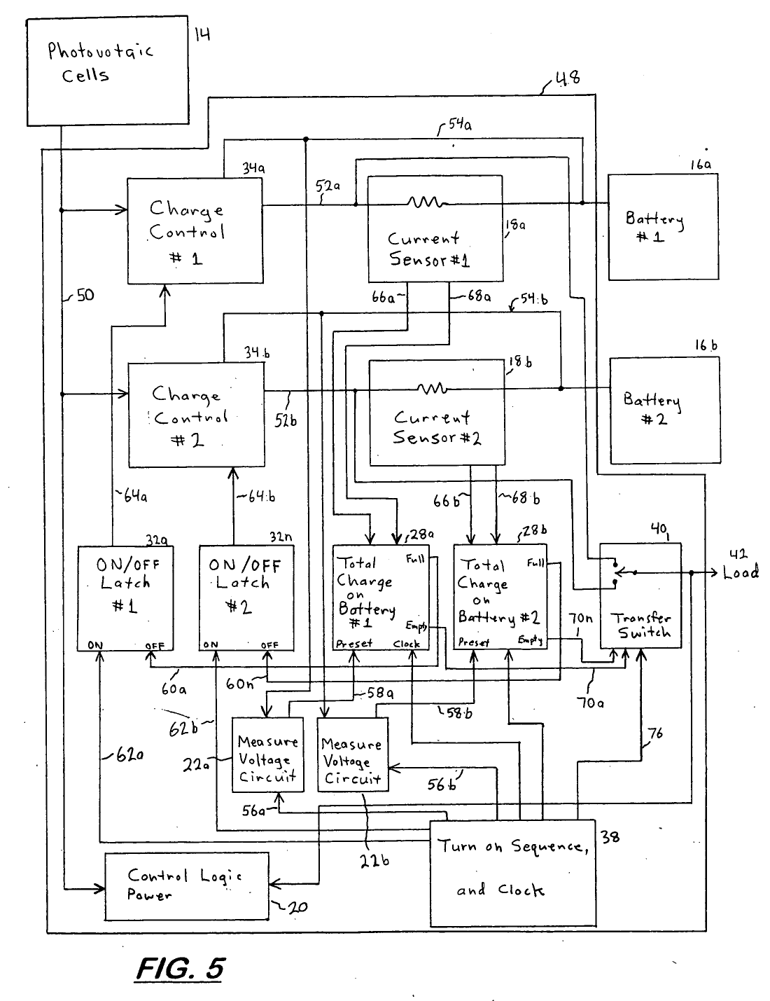

FIG. 5 shows an embodiment of a charge regulator system 48 that uses most of the functions and circuits of the battery charge regulator 12 of the present invention. This system resembles the charge regulator in FIG. 2, except that the system in FIG. 5 utilizes two of most of the functions and circuits of FIG. 2 and two batteries 16a and 16b. By using two batteries, one battery can be at rest while the other battery is supplying the load. In this manner, power can be continuously supplied to the load. The operation of the system is the same as described in the first embodiment of FIG. 2 except that the rest time for the battery alternates between the two batteries. When used with photovoltaic cells, this rest period will be every other day for each battery. The first battery is able to supply power during the rest time required by the second battery, and at a later time the second battery can supply power during the rest period of the first battery. It should be noted that although the system in FIG. 5 uses the embodiments shown in FIG. 2, the system could be comprised using the embodiments of FIG. 3 or FIG. 4. Functional blocks designated #a and #b have the same function for the same # as described for FIG. 2.

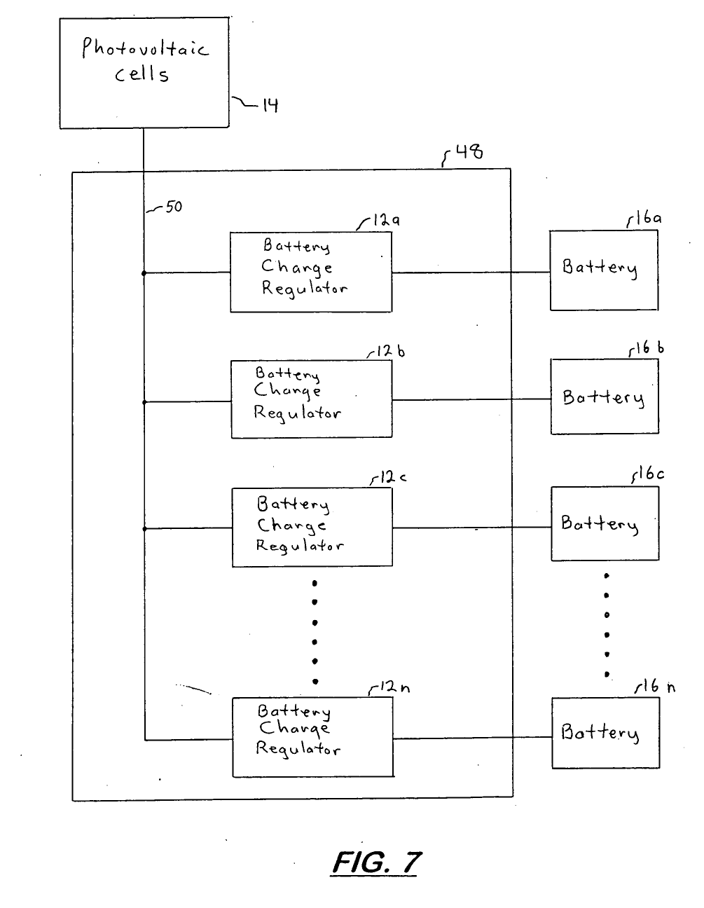

FIG. 7 is an embodiment of a charge regulator system 48 that uses multiple charge regulators 12a, . . . 12n of the present invention as they are in FIG. 2, and multiple batteries 16a, . . . 16n. The operation of this embodiment is the same as the embodiment of FIG. 5 except it is not limited to two battery charge regulators 12 of the present invention and multiple batteries can be used when one battery is at rest.

From the foregoing it will be appreciated that, although specific embodiments of the invention have been described herein for purposes of illustration, various modifications may be made without deviating from the spirit and scope of the invention.

1. A charge regulator for a battery, the charge regulator comprising:
a charging circuit operable to selectively couple the battery to a charging source; and
a control circuit operable to cause the charging circuit to provide a predetermined amount of charge to the battery based on a measurement of charge that the battery has received.

2. The charge regulator of claim 1, further comprising a charge measurement circuit operable to determine an initial charge of the battery.

3. The charge regulator of claim 2, wherein the charge measurement circuit measures an open-circuit voltage of the battery.

4. The charge regulator of claim 1, wherein the control circuit measures a current from the charging source into the battery.

5. The charge regulator of claim 1, wherein the control circuit stores a charge capacity of the battery.

6. The charge regulator of claim 1, further comprising a timing circuit operable to open-circuit the battery during a rest period, and operable to enable the charging circuit to couple the battery to the charging source during an activity period.

7. The charge regulator of claim 6, wherein the rest period is approximately six hours.

8. The charge regulator of claim 1, further comprising a load circuit operable to selectively couple the battery to a load.

9. The charge regulator of claim 6, further comprising a load circuit operable to selectively couple the battery to a load during the activity period, and operable to uncouple the battery from the load during the rest period.

10. The charge regulator of claim 1, wherein the charging source includes photovoltaic cells.

11. The charge regulator of claim 1 wherein the measurement of charge flowing into the battery comprises a measurement of current flowing into the battery.

12. The charge regulator of claim 1 wherein the measurement of charge flowing into the battery comprises a measurement of a time during which a known current flows into the battery.

13. The charge regulator of claim 1 wherein the control circuit is further operable to:
determine an initial charge in the battery after a predetermined rest period;
determine an amount of charge that when added to the initial charge equals a desired charge;
equating the desired charge with a battery voltage; and
wherein the measurement of charge flowing into the battery relates to a voltage across the battery.

14. A system comprising:
a charging source;
a first battery; and
a charge regulator including,
a first charging circuit operable to selectively couple the first battery to the charging source; and
a first control circuit operable to cause the first charging circuit to provide a predetermined amount of charge to the first battery based on a measurement of charge that the first battery has received.

15. The system of claim 14, wherein the charging source comprises a renewable charging source.

16. The system of claim 14, wherein the first battery comprises a lead acid battery.

17. The system of claim 14, further comprising:
a power source; and
a load circuit operable to selectively couple a load to the first battery or the power source.

18. The system of claim 14, further comprising:
a second battery;
a second charging circuit operable to selectively couple the second battery to the charging source; and
a second control circuit operable to cause the second charging circuit to provide a predetermined amount of charge to the second battery based on a measurement of charge that the second battery has received.

19. The system of claim 18, wherein the charge regulator further comprises a timing circuit operable to enable the first charging circuit to couple the first battery to the charging source and to open-circuit the second battery during a first period, and operable to enable the second charging circuit to couple the second battery to the charging source and to open-circuit the first battery during a second period.

20. The system of claim 18, wherein the charge regulator further comprises a load circuit operable to selectively couple a load to the first or second battery.

21. The charge regulator of claim 14 wherein the measurement of charge flowing into the first battery comprises a measurement of current flowing into the first battery.

22. The charge regulator of claim 14 wherein the measurement of charge flowing into the first battery comprises a measurement of a time during which a known current flows into the first battery.

23. The charge regulator of claim 14 wherein the first control circuit is further operable to:
determine an initial charge in the first battery after a predetermined rest period;
determine an amount of charge that when added to the initial charge equals a desired charge;
equating the desired charge with a battery voltage; and
wherein the measurement of charge flowing into the first battery relates to a voltage across the first battery.

24. A method of regulating charge in a battery, the method comprising:
determining an initial charge of the battery after a rest period during which the battery is open-circuited;
charging the battery;
monitoring the charge accumulated by the battery; and
ending the charging of the battery when the sum of the initial charge and the accumulated charge substantially equals a desired level.

25. The method of claim 24, wherein determining the initial charge of the battery includes measuring an open-circuit voltage of the battery.

26. The method of claim 24, wherein monitoring the charge accumulated by the battery includes measuring a current flowing into the battery.

27. The method of claim 24, wherein monitoring the charge accumulated by the battery includes measuring a net current into the battery.

28. The method of claim 24, wherein monitoring the charge accumulated by the battery includes measuring a current during a charging period, and multiplying the current by the duration of the charging period.

29. The method of claim 24, wherein monitoring the charge accumulated by the battery includes sampling a current over a charging period, averaging the current samples, and multiplying the average by the duration of the charging period.

30. The method of claim 24, wherein monitoring the charge accumulated by the battery includes integrating a current with respect to time.

31. The method of claim 24 wherein monitoring the charge accumulated by the battery includes determining the time that a known current is flowing into the battery.

32. The method of claim 24 wherein monitoring the charge accumulated by the battery includes making multiple battery voltage measurements.
